(19) United States
(12) Patent Application Publication
(10) Pub. No.: US 2022/0377192 A1
(43) Pub. Date: Nov. 24, 2022

(54) IMAGE READING APPARATUS AND IMAGE PROCESSING METHOD

(71) Applicant: KYOCERA Document Solutions Inc., Osaka (JP)

(72) Inventor: Takaaki Murase, Osaka (JP)

(21) Appl. No.: 17/747,870

(22) Filed: May 18, 2022

(30) Foreign Application Priority Data
May 20, 2021 (JP) 2021-085096

(51) Int. Cl. H04N 1/00

(52) U.S. Cl. CPC H04N 1/00718; H04N 1/00737; H04N 1/00769; H04N 1/00787

(57) ABSTRACT

An image reading apparatus includes an image reading portion, a rotation processing portion, a recognition processing portion and an inclination detecting portion. The image reading portion reads an image of a sheet conveyed through a conveyance path. The rotation processing portion applies rotation processing to the image of the sheet read by the image reading portion to generate a plurality of comparative images each having a different angle with respect to the conveyance direction of the sheet. The recognition processing portion applies recognition processing to a symbol of each of the plurality of comparative images to determine a corresponding matching degree. The inclination detecting portion detects the inclination of the image of the sheet based on the matching degrees.

### INCORPORATION BY REFERENCE

This application is based upon and claims the benefit of priority from the corresponding Japanese Patent Application No. 2021-085096 filed on May 20, 2021, the entire contents of which are incorporated herein by reference.

The present disclosure relates to an image reading apparatus and an image processing method.

### BACKGROUND

A known related art of the present disclosure includes an image reading apparatus (image processing apparatus) mounted with an ADF (automatic document feeder). The image reading apparatus of the related art is designed to correct inclination of an image of document in a read image as a means to prevent inclination (skew) of a sheet (document) with respect to a sheet reading position during conveyance of the sheet by the ADF. Specifically, as a countermeasure, the image reading apparatus of the related art corrects inclination of the image of document in the read image through detection of a sheet-edge shadow in the read image.

### SUMMARY

An image reading apparatus according to one aspect of the present disclosure includes an imaging reading portion, a rotation processing portion, a recognition processing portion and an inclination detecting portion. The image reading portion reads an image of a sheet conveyed through a conveyance path. The rotation processing portion applies a rotation processing to the image of the sheet read by the image reading portion to provide a plurality of comparative images each having a different angle with respect to a direction that the sheet is conveyed. The recognition processing portion determines a matching degree of each of the plurality of comparative images through application of symbol recognition processing. The inclination detecting portion detects an inclination of the image of the sheet based on the matching degree.

An image processing method according to another aspect of the present disclosure includes: reading an image of a sheet conveyed through a conveyance path by an image reading portion; applying a rotation processing to the image of the sheet read by the image reading portion to provide a plurality of comparative images each having a different angle with respect to a direction that the sheet is conveyed; applying a symbol recognition processing to each of the plurality of comparative images to determine a matching degree; and detecting an inclination of the image of the sheet based on the matching degree.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram showing a structure of an image reading apparatus according to a first embodiment.

FIG. 2 is a schematic diagram illustrating a structure of a primary part of the image reading apparatus according to the first embodiment.

FIG. 3 is an enlarged view illustrating an area Z1 in FIG. 2 in the structure of the image reading apparatus according to the first embodiment.

FIG. 4 is a block diagram illustrating one example of the structure of the image reading apparatus according to the first embodiment.

FIG. 5 is a conceptual view illustrating an image of a sheet read by the image reading apparatus according to the first embodiment.

FIG. 6 is a diagram illustrating an example of matching degrees of a plurality of comparative images having respective rotation angles in the image reading apparatus according to the first embodiment.

FIG. 7 is an example of table illustrating a correlation between the rotation angles and matching degrees of the plurality of comparative images in the image reading apparatus according to the first embodiment.

FIG. 8 is a conceptual view illustrating the directions of the sheets set in the image reading apparatus according to the first embodiment.

FIG. 9 is a flowchart illustrating an example of an image processing method according to the first embodiment.

FIG. 10 is a block diagram illustrating an example of the structure of an image reading apparatus according to a second embodiment.

### DETAILED DESCRIPTION

An embodiment of the present disclosure will be described below with reference to the attached drawings. The embodiment below is merely a specified example of the present disclosure and is not intended to limit the technical scope of the present disclosure.

(First Embodiment)

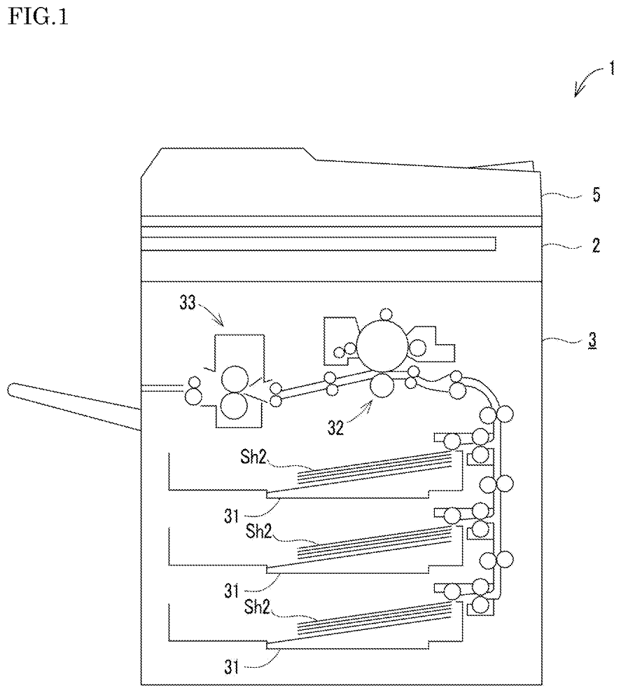

(1) Schematic structure of an image reading apparatus First, a schematic structure of an image reading apparatus 1 according to the first embodiment will be described with reference to FIGS. 1 to 4.

One example of the image reading apparatus according to the embodiment is a multifunction peripheral having multiple functions including a scanning function to obtain an image (image data) from document, a printing function to form an image based on the image data, a facsimile function, and a copying function. As illustrated in FIG. 1, this image reading apparatus 1 is an image processing apparatus including an image reading portion 2 and an image forming portion 3. The image reading apparatus 1 may not be the multifunction peripheral and may be scanning, facsimile and copying machines which have at least an image reading function.

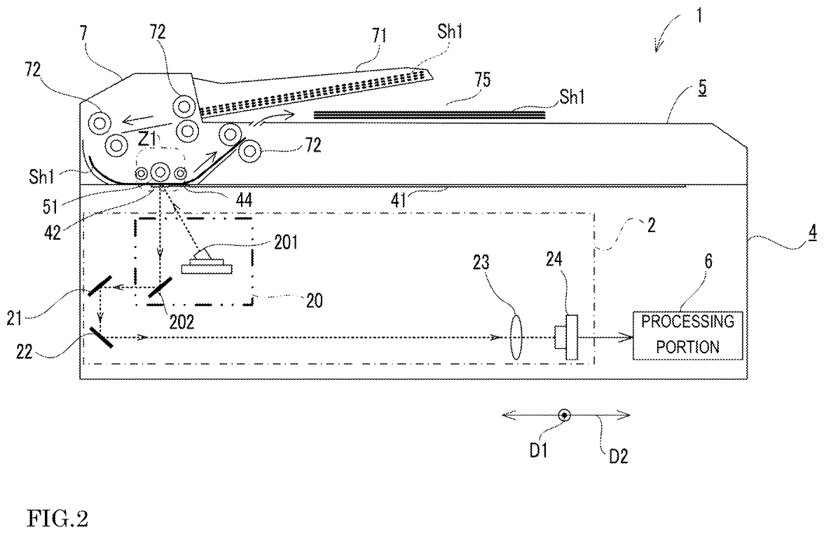

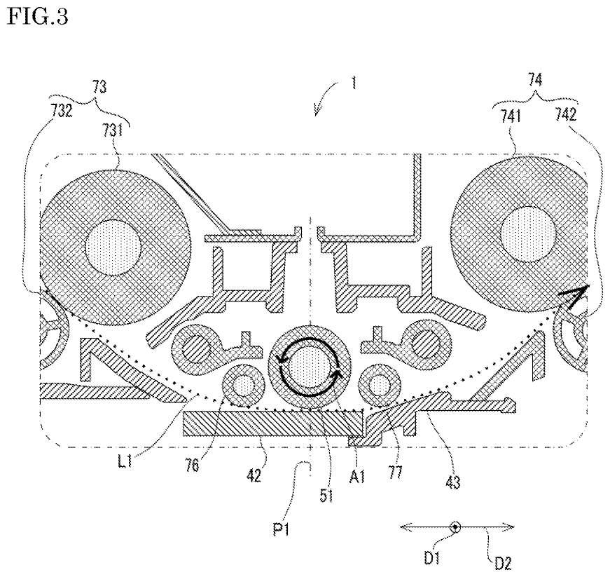

The image reading portion 2 has a function to read an image from a sheet Sh1 (see FIG. 2) and is placed, for example, above an image forming portion 3. The image forming portion 3 has a function to form an image read by the image reading portion 2 on a different sheet Sh2 (see FIG. 1). The image reading portion 2 reads an image of the sheet Sh1 conveyed through a conveyance path L1 (see FIG. 3). The image forming portion 3 in this embodiment includes, for example, a plurality of sheet feed trays 31, a transfer device 32 and a fixing device 33. The image forming portion 3 forms an image on the different sheet Sh2 by an electrophotographic method based on an image (image data) outputted from the image reading portion 2. The image forming portion 3 may form an image (image data) inputted from an information processing device, etc., external of the image reading apparatus 1 on a sheet (different sheet Sh2), besides an image read by the image reading portion 2. The image forming portion 3 may be configured to form an image on a sheet (different sheet Sh2) by an inkjet method, for example, besides the electrophotographic method.

As illustrated in FIG. 2, the image reading apparatus 1 includes an apparatus body 4 and a document cover 5. The document cover 5 is disposed on the apparatus body 4 so as to be able to open/close (pivot) with respect to the apparatus body 4. The document cover 5 in the “open” state makes the upper surface of the apparatus body 4 be exposed while the cover 5 in the “close” state makes the upper surface thereof be covered by the document cover 5.

Accordingly, exposure and non-exposure of the upper surface of the apparatus body 4 are shifted by an open/close operation of the document cover 5. A support portion (hinge portion) for opening/closing the document cover 5 is provided with a cover-opening detection sensor such as a limit switch. With this, when the document cover 5 is opened by a user for reading of an image of a document, the cover-open detection sensor detects it and sends a detection signal (cover-open detection signal) to a processing portion 6 described later.

The apparatus body 4 of the image reading apparatus 1 includes a first contact glass 41, a second contact glass 42, the image reading portion 2 and a processing portion 6. The first and second contact glasses 41, 42 form a part of the upper surface of the apparatus body 4. This allows taking of light from an upper surface side of (above) the apparatus body 4 into an inside of the apparatus body 4 through the first and second contact glasses 41, 42. A document (sheet Sh1) to be read is placed on the first contact glass 41. The function of the second contact glass 42 will be described later. The image reading portion 2 reads an image of the sheet Sh1 through the first contact glass 41 or second contact glass 42. The processing portion 6 is electrically connected to the image reading portion 2. Data of image (image data) read by the imaging reading portion is sent to the processing portion 6. Accordingly, the image reading apparatus 1 includes in the apparatus body 4 the image reading portion for reading an image of the sheet Sh1 and the processing portion 6 for receiving image data.

The image reading portion 2 includes a reading unit 20, mirrors 21, 22, an optical lens 23 and an optical sensor 24 (image sensor). As one example, the image reading portion 2 in this embodiment employs a CCD (Charge Coupled Device) method with use of the optical sensor 24 in which CCD is used. Alternatively, the image reading portion 2 may employ a CIS (Contact Image Sensor) method instead of the CCD method.

The reading unit 20 includes a light source 201 and a mirror 202. The unit 20 can move in a sub-scanning direction D2 (see FIG. 2) by a driving mechanism using a drive motor such as a stepping motor. The light source 201 includes a plurality of light emitting elements, e.g., a plurality of LEDs (Light Emitting Diodes), arranged in a main scanning direction D1 (direction orthogonal to the sheet of FIG. 2). The light source 201 emits light linearly traveling in the main scanning direction D1 (line light) toward the first contact glass 41 placed on the upper surface of the apparatus body 4. Thus, when the reading unit 20 is moved by the driving motor in the sub-scanning direction D2, the linear light emitted from the light source 201 to the first contact glass 41 is scanned in the sub-scanning direction D2. The main scanning direction D1 and the sub-scanning direction D2 of the image reading portion 2 are directed along the upper surface of the apparatus body 4 and are orthogonal to each other.

The mirror 202 (first mirror) reflects the light emitted from the light source 201 and reflected at the sheet Sh1 or a rear surface (bottom surface) of the document cover 5 toward the mirror 21 (second mirror). The light reflected at the mirror 202 is directed to the optical lens 23 via the mirror 21 and the mirror 22 (third mirror). The optical lens 23 gathers the incident light and directs it to the optical sensor 24.

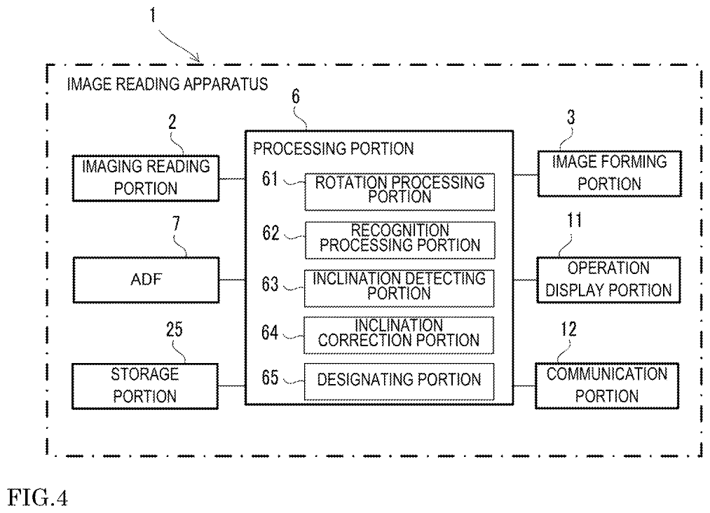

The optical sensor 24 is a photoelectric conversion element that converts received light into an electric signal (voltage or current) in accordance with the amount of light (luminance intensity). Data of the amount of light that the optical sensor 24 has received is subjected to an appropriate pre-processing in the processing portion 6 or in a pre-circuit in a pre-stage of the processing portion 6. The pre-processing includes a y correction processing for the light amount data, a color correction processing for adjusting RGB color balance, and a color conversion processing from RGB data to CMYK data. The light amount data after the pre-processing is stored in a storage portion 25 (see FIG. 4), which will be described later, as an image (read image) read by the image reading portion 2. The storage portion 25 may be included in the processing portion 6.

The document cover 5 includes a document conveyance device 7. The document conveyance device 7 is an ADF (Auto Document Feeder), so that it is expressed as “ADF” in FIG. 4 and is referred to as “ADF 7” in the following description. The ADF 7 sequentially conveys a single or a plurality of sheets Sh1 set on a document setting portion 71 of the document cover 5 by plural pairs of conveying rollers 72. Here, the ADF 7 conveys the sheet Sh1 rightward in the sub-scanning direction D2 on a reading position P1 (see FIG. 3) fixed on the second contact glass 42. In other words, the ADF 7 conveys the sheet Sh1 through the conveyance path L1 including the reading position P1 on the second contact glass 42. As illustrated in FIG. 2, in the image reading portion 2, the reading unit 20 positioned below the reading position P1 can read an image of the sheet Sh1 being conveyed in the conveyance path L1 by the ADF 7 at the reading position P1. That is, the image reading apparatus 1 includes the ADF 7, which conveys the sheet Sh1 through the conveyance path L1, in the document cover 5.

The document cover 5 of the image reading apparatus 1 includes a reference member 51. The reference member 51 faces against the second contact glass 42 when the document cover 5 is in a “close” state. The reading position P1 takes place at the center of the surface (bottom surface) of the reference member 51 facing against the second contact glass 42 in the sub-scanning direction D2. As illustrated in FIG. 3, there is kept a gap between the reference member 51 and the second contact glass 42, the gap forming part of the conveyance path L1. With this, the sheet Sh1 set on the document setting portion 71 is conveyed by the ADF 7 so as to pass the reading position P1 rightward in the sub-scanning direction D2 through the gap between the reference member 51 and the second contact glass 42. The reference member 51 functions as a conveyance guide (sheet-pass guide) to guide a route of the sheet Sh1 passing through the gap between the reference member 51 and the second contact glass 42.

As described above, the image reading apparatus 1 includes the reference member 51 disposed so as to face against the image reading portion 2 interposing the conveyance path L1. With respect to the image reading portion 2, the reference member 51 may be positioned at a location where an image of the reference member 51 is able to be read from an opposite side interposing the conveyance path L1. That is a location where the image of the reference member 51 is allowed to be read through or over the conveyance path L1. Accordingly, the reference member 51 is positioned so that at least part of the image reading portion 2 for receiving light of an image to be read faces against the reference member 51 interposing the conveyance path L1. In other words, the reference member 51 in this embodiment is positioned so as to face against at least the reading unit 20 of the image reading portion 2 interposing the conveyance path L1. The surface of the reference member 51 has uniformly a single color. In this embodiment it has uniformly a white color as an example.

The reference member 51 in this embodiment is composed of a rotatable roller member, for example, functioning as a conveying guide-roller that guides the sheet Sh1 to pass the gap between the reference member 51 and the second contact glass 42. The reference member 51 functioning as a conveying guide-roller is driven by a driving force, e.g., a motor, to rotate in a direction (counterclockwise direction) illustrated with the arrow A in FIG. 3. Here, the conveying guide-roller or the reference member 51 conveys the sheet Sh1 while pushing it downward (toward the side of the second contact glass 42). The reference member 51 may be composed of a non-rotating conveyance guide, shading plate or shading roller, for example, instead of the conveying guide-roller.

The ADF 7 includes a first conveying roller pair 73 at a given position upstream the reference member 51 in the conveyance direction of the sheet Sh1 (left side in FIG. 3). The first conveying roller pair 73 includes a first driving roller 731 and a first driven roller 732. The first drive roller 731 and the first driven roller 732 are in contact to each other with a predetermined pressure. The first conveying roller pair 73 sandwiches the sheet Sh1 between the first drive roller 731 and the first driven roller 732 to convey the sheet Sh1 to the reading position P1.

The ADF 7 further includes a second conveying roller pair 74 at a given location downstream the reference member 51 in the conveyance direction of the sheet Sh1 (right side in FIG. 3). The second conveying roller pair 74 includes a second drive roller 741 and a second driven roller 742. The second drive roller 741 and the second driven roller 742 are in contact to each other with a predetermined pressure. The second conveying roller pair 74 sandwiches the sheet Sh1, which has passed through the reading position P1, between the second drive roller 741 and the second driven roller 742 to convey the sheet Sh1 to another conveying roller pair 72 at the side of a discharge portion 75 on the document cover 5 (see FIG. 2).

The ADF 7 includes a first driven rolling-member 76 and a second driven rolling-member 77. The first driven rolling-member 76 is placed between the first conveying roller pair 73 and the reference member 51 and the second driven rolling-member is placed between the reference member 51 and the second conveying roller pair 74 along the conveyance path of the sheet Sh1. Furthermore, a guide member 43 is provided downstream the second contact glass 42 of the upper surface of the apparatus body 4 in the conveyance direction of the sheet Sh1. The guide member 43 scoops and guides the sheet Sh1 conveyed to the gap between the reference member 51 and the second contact glass 42.

The first driven rolling-member 76 faces against the second contact glass 42 with a predetermined gap therebetween, forming the conveyance path L1 for the sheet Sh1 together with the second contact glass 42. The first driven rolling-member 76 conveys the sheet Sh1 while pushing it downward. The second driven rolling-member 77 faces against the guide member 43 with a predetermined gap between them, forming the conveyance path L1 for the sheet Sh1 together with the guide member 43. The second driven rolling-member 77 pushes the sheet Sh1 downward for conveyance.

With the configuration of the ADF 7 described above, a sheet Sh1 set on the document setting portion 71 is conveyed by the first conveying roller pair 73. Then the sheet Sh1 is guided and conveyed by the first driven rolling-member 76 and passes through the gap (reading position P1) between the reference member 51 and the second contact glass 42. Finally, the sheet Sh1 is conveyed by the second driven rolling-member 77, the second conveying roller pair 74 and another conveying roller pair 72 to the discharge portion 75 on the upper surface of the document cover 5.

The processing portion 6 collectively controls the image reading apparatus 1. The processing portion 6 is mainly composed of a computer system having one or more processors and one or more memories. The processing portion 6 in the image reading apparatus 1 functions as one or more processors execute a program. The program may be recorded in the memory (or storage portion 25) in advance, may be provided through a telecommunication line such as internet or may be recorded in a non-temporary recording medium that can be read by a computer system such as an optical disc. One or more processors each are composed of one or more electronic circuits including semiconductor integrated circuits. The computer system here includes a microcontroller having one or more processors and one or more memories. The processing portion 6 includes a memory used as a temporary storage memory (working area) for various processes that the processing portion 6 executes. The processing portion 6 may be a control portion provided separately from the main control portion collectively controlling the image reading apparatus 1.

The storage portion 25 includes one or more non-volatile memories and stores in advance information such as control programs for the processing portion 6 to execute various processes.

The image reading apparatus 1 described above is able to read an image through two types of reading methods that are a first reading method and a second reading method. The first reading method is also referred to as a document-fixed reading method. The second reading method is also referred to as a sheet-through reading method. Reading operation using the first or second reading method may be selectively taken (switched) by an operation of user.

In the first reading method, an image of document placed on the first contact glass 41 is read by the image reading portion 2 while the reading unit 20 is moved below the first contact glass 41 in the sub-scanning direction D2. Specifically, an image reading instruction is inputted after the document is placed on the first contact glass 41 and the upper surface of the apparatus body 4 is covered with the document cover 5. Then, the light source 201 sequentially emits light per one line in a continuous manner while the reading unit 20 of the image reading apparatus 1 is moved from a home position at a side of the second contact glass 42 to an opposite side thereof (right side in FIG. 2). Here, the light reflected from the document (or the under surface of the document cover 5) is led to the optical sensor 24 via the mirrors 202, 21, 22 and the optical lens 23. As above, in the reading operation using the document-fixed reading method, the image reading apparatus 1 is able to read an image of the document placed on the first contact glass 41 through the first contact glass 41.

In the second reading method, an image of the sheet Sh1 is read by the image reading portion 2 at the reading position P1 when the sheet Sh1 (document) passes the reading position P1 as it is conveyed by the ADF 7. Specifically, an image reading instruction is inputted after document is set on the document setting portion 71 and the upper surface of the apparatus body 5 is covered with the document cover 5. Then, the reading unit 20 of the image reading apparatus 1 is moved to a predetermined location (sheet-through position) corresponding to the reading position P1 below the second contact glass 42. Here, the light source 201 of the image reading apparatus 1 sequentially emits light per one line in a continuous manner while the sheet Sh1 is moved by the ADF 7 so as to pass the reading position in the sub-scanning direction D2. The reading operation of the image reading portion 2 starts after predetermined time passes since the sheet Sh1 is detected by a document sensor. Then, the light reflected at the sheet Sh1 is led to the optical sensor via the mirrors 202, 22, 21 and the optical lens 23. As above, in the reading operation using the sheet-through reading method, the image reading apparatus 1 is able to read an image of the sheet Sh1 conveyed by the ADF 7 on the second contact glass 42 through the second contact glass 42.

In the second reading method in this embodiment, an image of the sheet Sh1 passing between the reference member 51 and the second contact glass 42 is read by the image reading portion 2 due to the reference member 51 being provided. This prevents defect caused by, for example, out of focus, decrease in the amount of reflected light from the sheet Sh1, and departure of the sheet Sh1 from the second contact glass 42.

The image reading apparatus 1 is able to obtain white reference data by reading an image on the surface of a white reference plate 44 (see FIG. 2) provided separately from the reference member 51. The surface of the white reference plate 44 has uniformly a single color, and it has uniformly a white color as an example in this embodiment. The white reference plate 44 is disposed between the first contact glass 41 and the second contact glass 42 in the sub-scanning direction D2, for example. The image reading apparatus 1 obtains reference data of a plurality of lines by moving the reading unit 20 below the white reference plate 44 to start reading an image, and transfers the reference data to a shading correction storage area of the storage portion 25. The shading correction storage area is provided in response to the number of elements (number of pixels) of the optical sensor 24 in the main scanning direction D1. Based on the reference data transferred to the shading correction storage area, the density value of the image data is corrected so as to be uniform in the main scanning direction D1.

The image to be read by the image reading apparatus 1 is composed of a plurality of pixels, each pixel having a density value corresponding to the density. In this embodiment, the density of each pixel is represented by 256 stages (eight bits) from “0” to “255”. The relation between the density and the density value is determined such that lower density has a larger density value. Thus, the density value of each pixel of the image on the surface of the white reference plate 44 to be obtained by the reading operation described above basically becomes a relatively large value corresponding to white, particularly a value near “255”.

As illustrated in FIG. 4, the image reading apparatus 1 includes an image reading portion 2, an image forming portion 3 and an ADF 7, as well as an operation display portion 11 and a communication portion 12.

The operation display portion 11 is a user interface in the image reading apparatus 1. The operation display portion 11 includes a display portion, e.g., a liquid crystal display that displays various information in response to a control instruction from the processing portion 6 and an operation portion, e.g., a switch or touch panel that inputs various information to the processing portion 6 in response to the operation of user. The image reading apparatus 1 functioning as a user interface may include a sound output portion and a sound input portion, for example, in addition to or instead of the operation display portion 11. The communication portion 12 is an interface to perform data communication between the image reading apparatus 1 and an external device connected via a communication network such as an internet or LAN (Local Area Network).

(2) Structure for Correcting Inclination

In the second reading method (sheet-through reading method) of the image reading apparatus 1, an image of the sheet to be read inclines if the sheet inclines during conveyance by the ADF 7. Accordingly, employing a means to correct an inclination of an image in the image reading apparatus 1 is desired.

A known means to correct an inclination of an image is a mechanical resist mechanism, for example. The mechanical resist mechanism uses resist rollers disposed at an upstream side of a reading position P1 in the conveyance path L1 to correct an inclination (skew correction) of a sheet Sh1 itself being conveyed. Specifically, the mechanical resist mechanism corrects the inclination of the sheet Sh1 by causing a tip end of the sheet Sh1 being conveyed on the conveyor path L1 to collide with nip portions of the resist rollers that are in a stop state.

As is above, the mechanical resist mechanism corrects the inclination of the sheet Sh1 by rotating the resist rollers after the posture of the sheet Sh1 is adjusted (inclination is corrected). Unfortunately, with the mechanical resist mechanism, time required to read a single sheet Sh1 becomes long and noise of the sheet Sh1 colliding the resist rollers becomes a problem, due to frequent stop/rotation operations of the resist rollers. Therefore, as an alternative to the mechanical resist mechanism, a means to correct the inclination of an image read by the image reading portion 2 is studied, instead of the means to correct the inclination of the sheet Sh1 itself. In this case, the image reading apparatus 1 includes a means to detect an inclination of the sheet Sh1 being conveyed and corrects the inclination of the image after the inclination is detected.

Here, an image reading apparatus (image processing apparatus) mounted with an ADF is known as a related art. The image reading apparatus of the related art corrects an inclination of a document image in the read image to take a countermeasure against an inclination (skew) of the sheet (document), being conveyed by the ADF, with respect to a reading position of the sheet. Specifically, as a countermeasure against the skew, the image reading apparatus of the related art detects an inclination based on a shadow of the edge of the sheet found in the read image to correct the inclination of the document image in the read image.

In the structure of the related art described above, the inclination of the image of the sheet could not be detected from the edge due to a waved sheet providing an edge with a shadowed location and an un-shadowed location or due to a sheet with a small thickness (thin) not providing sufficient shadow.

Accordingly, the structure described below is employed in the present embodiment, providing an image reading apparatus 1 that easily detects an inclination of an image of a sheet Sh1.

Specifically, as illustrated in FIG. 4, the image reading apparatus 1 according to the present embodiment includes a rotation processing portion 61, a recognition processing portion 62 and an inclination detecting portion 63, in addition to an image reading portion 2. In the present embodiment, the rotation processing portion 61, the recognition processing portion 62 and the inclination detecting portion 63 are embodied in the processing portion 6. Furthermore, in the present embodiment, the processing portion 6 additionally has functions of an inclination correction portion 64 and a designating portion 65. In other words, in the image reading apparatus 1 according to the present embodiment, the processing portion 6 functions as the rotation processing portion 61, the recognition processing portion 62, the inclination detecting portion 63, the inclination correction portion 64 and the designating portion 63.

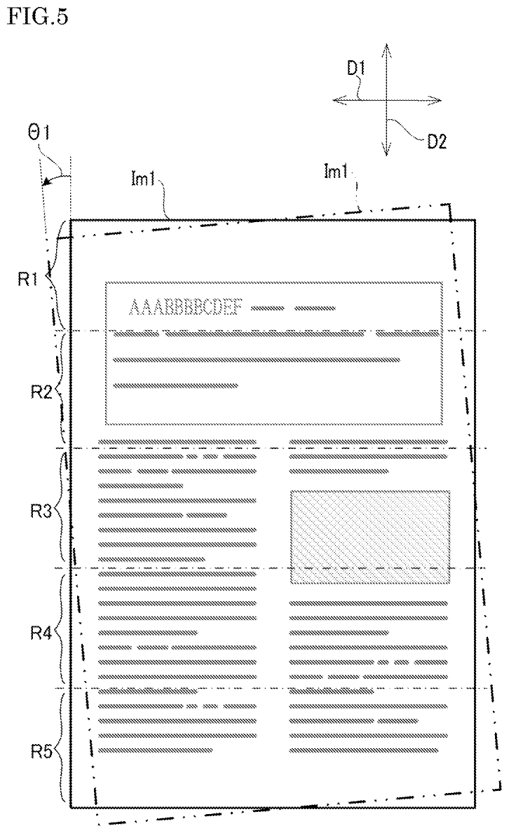

The rotation processing portion 61 applies rotation processing to an image Im1 (see FIG. 5) of the sheet Sh1 read by the image reading portion and generates a plurality of comparative images each having a different angle with respect to the conveyance direction of the sheet Sh1. Specifically, as exemplified in FIG. 5, the rotation processing portion 61 rotates the image Im1 of the sheet Sh1 read by the image reading portion by the rotation angle θ1 on the basis of the conveyance direction of the sheet Sh1. The conveyance direction of the sheet Sh1 in this embodiment is a sub-scanning direction D2 of the image reading portion 2, as an example. Thus, the rotation processing portion 61 rotates the image Im1 by the rotation angle θ1 with respect to the sub-scanning direction D2. This rotation processing provides an image Im1 of before-rotation illustrated with a solid line in FIG. 5 and another image Im1 of after-rotation illustrated with an imaginary line (two-dot chain line) in FIG. 5, which are assigned as the comparative images of the image Im1. Here, with respect to the conveyance direction of the sheet Sh1, the angle of the image Im1 of before-rotation is 0 (degree) and the angle of another image Im1 of after-rotation is θ1 (degrees). That is, the images before and after the rotation provide multiple comparative images each having a different angle with respect to the conveyance direction of the sheet Sh1 (here the sub-scanning direction D2).

In this embodiment, the rotation processing portion 6 performs multiple times (two times or more) of processing at each predetermined angle to generate three or more of comparative images. That is, with multiple times of processing, three or more comparative images are generated including at least an image Im1 before the first rotation processing, another image Im1 after the first rotation processing, and further another image Im1 after the second rotation processing. In this embodiment, a pitch angle to rotate an image Im1 by a single rotation processing is 0.5 degrees, as an example. The rotation processing portion 61 performs five times of rotation processing in a plus direction (anticlockwise direction in the example of FIG. 5) by a pitch angle (0.5 degrees) and in a minus direction (clockwise direction in the example of FIG. 5) by a pitch angle (0.5 degrees), both on the basis of the initial rotation angle. With this, the rotation processing portion 61 performs 10 times of rotation processing in the range of 5.0 degrees with 2.5 degrees in the plus direction and 2.5 degrees in the minus direction with respect to the initial rotation angle, generating total of 11 comparative images with intervals of 0.5 degrees.

Here, the pitch angle is not limited to 0.5 degrees and may be, for example, less than 0.5 degrees including 0.1, 0.2, 0.3 and 0.4 degrees or may be greater than 0.5 degrees including 1.0, 2.0 and 3.0 degrees. In addition, the number of rotation that the rotation processing portion 61 performs is not limited to the number above and may be less than five times (one, two, three or four times, for example) or more than five times (six, seven, 10 or 15 times, for example). Furthermore, the direction of the rotation processing by the rotation processing portion 61 is not limited to both of the plus and minus directions and may be in the plus direction only or the minus direction only.

The initial rotation angle is determined by the angle with respect to the conveyance direction (the sub-scanning direction D2, here) of the sheet Sh1 and is set to 0 degrees at the time of shipment from the factory or at the initial state (default) after resetting. In the initial state, the rotation processing portion 61 rotates an image Im1 in both the plus and minus directions for multiple times (five times) each by a pitch angle (0.5 degrees) with respect to the conveyance direction of the sheet Sh1. The initial rotation angle is not fixed and can be selectively altered as the value stored in the storage portion 25 is updated. That is, the rotation processing portion 61 starts the rotation processing of an image Im1 of the sheet Sh1 on the basis of the initial rotation angle read out from the storage portion 25. As one example, when the initial rotation angle is “1.0 degree”, the rotation processing portion 61 rotates the image Im1 for multiple times (five times) in both the plus and minus directions by the pitch angle (0.5 degrees) on the basis of the same image Im1 that has been rotated 1.0 degree in the plus direction in advance.

The recognition processing portion 62 performs symbol recognition processing for each of a plurality of comparative images to determine a matching degree. The “symbol” in this disclosure indicates a medium that assists information transmission, particularly a figure with a meaning, and includes, for example, letters, numbers, figures and pictures in addition to marks (symbol in a narrow sense). As an example, the recognition processing portion 62 in this embodiment is supposed to perform OCR (Optical Character Recognition) that recognizes letters and numbers as symbol. In other words, the target of the recognition processing (recognition target) by the recognition processing portion 62 includes letters and numbers. The “matching degree” in this disclosure means that a certain symbol is “surely likely” the certain symbol in the recognition processing that the recognition processing portion 62 performs. The “matching degree” includes the degree of matching (matching rate) with respect to a template in a pattern matching, the degree of matching with respect to a standard pattern of feature amount (OCR score), and literacy rate (letter recognition rate). In other words, in the optical letter recognition by a pattern matching with simple recognition processing, when a target of recognition of letter “A” in comparative images is compared with the letter “A” in the template, the degree of matching (matching rate) is determined as the “matching degree”.

Specifically, the recognition processing portion 62 performs recognition processing (OCR) for a plurality of comparative images generated in the rotation processing portion 61 to determine the matching degree. As an example, the recognition processing portion 62 in this embodiment performs recognition processing using feature amount of letters and numbers which are target of recognition. That is, the recognition processing portion 62 performs a series of processing for optical letter recognition such as normalization, feature extraction, matching processing and knowledge processing for letters and numbers that are recognition target to determine the matching degree. The recognition processing portion 62 in this matching processing compares the feature (feature amount) extracted by the feature extraction with standard patterns and determines the standard pattern having the shortest Euclidean distance as the recognition result, for example. Here, the recognition processing portion 62 determines the matching degree in accordance with the Euclidean distance with respect to the recognition result of the standard pattern and determines that the Euclidean distance with a smaller distance has higher matching degree. When a plurality of letters is included as target of recognition in the recognition processing portion 62, the recognition processing portion determines the matching degree of each of the letters and determines a representative value (average, median, mode, minimum or maximum value) of the matching degree by statistical processing. Then, the recognition processing portion 62 determines the representative value of the determined matching degree as a matching degree of a single comparative image.

The recognition processing portion 62 outputs the matching degree of each of the plurality of comparative images determined to the inclination detecting portion 63. In this embodiment, the recognition processing portion 62 outputs only the matching degree of each comparative image since the result of the recognition processing (recognition result) itself is not particularly used. Alternative to this configuration, the recognition processing result of the recognition processing portion 62 may be outputted for separate use as a result of optical letter recognition, for example.

The recognition processing portion 62 in this embodiment applies recognition processing to at least one of the zones of the image Im1 of the sheet Sh1 divided into a plurality of zones R1, R2, R3, R3, R5. In the example of FIG. 5, the image Im1 is divided into five zones R1, R2, R3, R4, R5 in the conveyance direction (sub-scanning direction D2) of the sheet Sh1. In this case, the recognition processing portion 62 may apply recognition processing to only one of the zones R1, R2, R3, R4, R5 (for example, zone R1) to determine the matching degree. This configuration reduces processing load needed for recognition processing, improve processing speed and reduce use of memory resource, compared to the case where the recognition processing is applied to the entirety of the image Im1. The number of zones dividing an image is not limited to five and may be less than five (two, three or four) or more than five (10 or 15, for example), for example. The direction to divide into a plurality of zones R1, R2, R3, R4, R5 is not limited to the conveyance direction of the sheet Sh1.

The inclination detecting portion 63 detects an inclination of the image Im1 of the sheet Sh1 based on the matching degree. The inclination detecting portion 63 detects an inclination of the image Im1 of the original sheet Sh1 (the sheet Sh1 before applied with rotation processing by the rotation processing portion 61) based on the matching degrees of a plurality of comparative images inputted from the recognition processing portion 62. Specifically, if the image Im1 of the original sheet Sh1 inclines with respect to the conveyance direction (sub-scanning direction D2), rotating the image Im1 so as to cancel the inclination will result in the matching degree of highest, the matching degree being obtained through the recognition processing by the recognition processing portion 62. Accordingly, the inclination detecting portion 63 in the embodiment determines a positive-negative reversed rotation angle of the highest matching angle θ1 among a plurality of comparative images each having a different rotation angle θ1 as an inclination angle of the image Im1 of the original sheet Sh1. As described above, in the image reading apparatus 1 according to the present embodiment, the inclination of the image of the sheet Sh1 is detected based on the matching degree of the recognition processing and not from the edge of the sheet, resulting in an easy detection of the inclination of the image of the sheet Sh1, particularly in case the edge can be hardly detected.

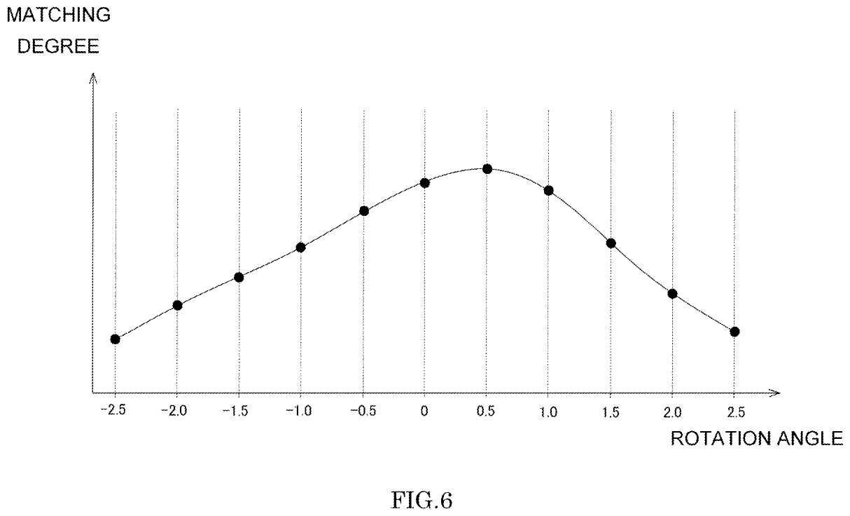

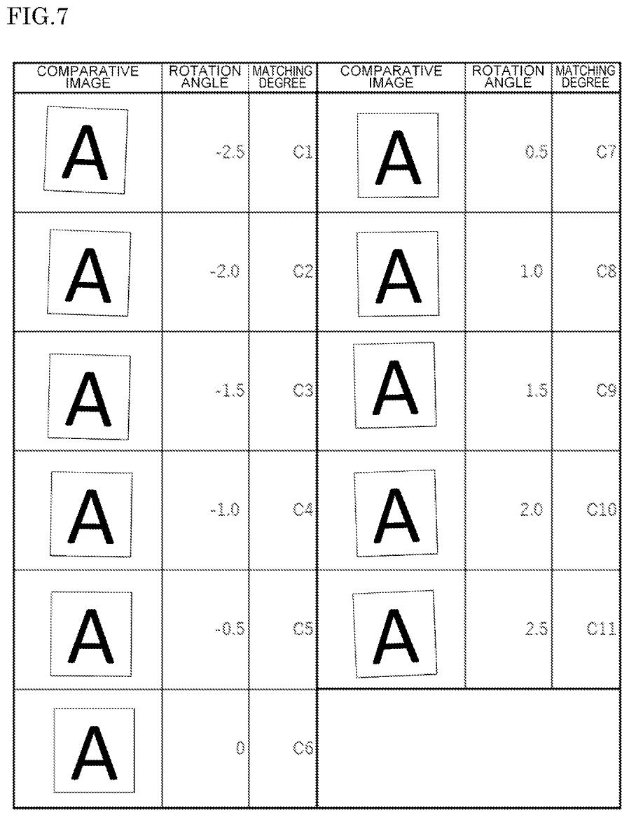

One example of inclination detecting processing by the inclination detecting portion 63 will be described below with reference to FIGS. 6 and 7, wherein the image Im1 of the original sheet Sh1 inclines “0.5 degrees” in a minus direction (clockwise direction) with respect to the conveyance direction. FIG. 6 is a graph plotting the matching degrees of a plurality of comparative images (here, 11 images) each having a different rotation angle, wherein the horizontal axis indicates the rotation angle while the vertical axis indicates the matching degree. FIG. 7 is a table illustrating the corresponding relations between the rotation angles (−2.5 to 2.5) and the matching degrees (C1 to C11) of the comparative images. The table illustrated in FIG. 7 is temporarily stored in the storage portion 25 based on the output from the recognition processing portion 62. Here, as illustrated in FIG. 6, the comparative image corresponding to the image Im1 rotated “0.5 degrees” in the plus direction (counterclockwise direction) so as to cancel the inclination (−0.5 degrees) of the image Im1 of the original sheet Sh1 becomes the highest matching degree. Accordingly, the inclination detecting portion 63 detects the inclination of “−0.5 degrees” as the inclination of the image Im1 since the comparative image with the rotation angle θ1 of “0.5 degrees” has the highest matching degree C7 (see FIG. 7) among the matching degrees C1 to C11.

Here, the inclination detecting portion 63 is not restricted to detect the inclination from the rotation angle θ1 of the comparative image of the highest matching degree among a plurality of comparative images. For example, the inclination detecting portion 63 may detect the inclination from the rotation angle θ of a comparative image of not-highest matching degree by removing through a filter a matching degree that is considered to have an error value in case, for example, of a swift change rate difference between adjacent two comparative images. The inclination detecting portion 63 may specify a comparative image to detect an inclination by paying attention to the distribution of the matching degrees of a plurality of comparative images as illustrated in FIG. 6.

The inclination detecting portion 63 may detect an inclination of each of a plurality of zones R1 to R5 when the recognition processing portion 62 applies recognition processing to each of the zones R1 to R5. In this case, the inclination detecting portion 63 detects an inclination of each of the zones R1 to R5 and does not detect a single inclination of the image Im1 of the single sheet Sh1. As an example, the inclination detecting portion 63 detects an inclination of “−0.5 degrees” for the zone R1 and an inclination of “−1.5 degrees” for the zone R5 both based on the matching degrees of a plurality of comparative images. Detecting the inclination per each zone allows precise fine detection.

The inclination correcting portion 64 corrects an inclination of the image Im1 read by the image reading portion 2 in accordance with the inclination detected by the inclination detecting portion 63. That is, the image reading apparatus 1 according to the present embodiment employs a means to correct an inclination of the image Im1 of the sheet Sh1 read by the image reading portion 2 in place of the mechanical resist mechanism that corrects an inclination of the sheet Sh1 itself being conveyed. Thus, the image reading apparatus 1 includes the inclination detecting portion 63 as a means to detect an inclination of the sheet Sh1 to be conveyed. Specifically, the inclination correcting portion 64 determines the presence of inclination when the angle of inclination (inclination angle) detected by the inclination detecting portion 63 has a predetermined angle (0.5 degrees, for example).

Upon determination of the presence of inclination of the image Im1 of a sheet Sh1, the inclination correcting portion 64 corrects the inclination of the image Im1 read by the image reading portion 2 by rotating the image Im1. Specifically, the inclination correcting portion 64 rotates the image Im1 in a direction opposite the inclined direction for the rotation angle detected by the inclination detecting portion 63, thereby correcting the inclination of the image Im1 of the sheet Sh1 so that the sheet Sh1 has a non-inclined upright direction. As an example, when the image of the original sheet Sh1 inclines “0.5 degrees” in a minus direction with respect to the conveyance direction of the sheet Sh1, the inclination correcting portion 64 rotates the image Im1 of the sheet Sh1 “0.5 degrees” in a plus direction in response to the inclination degree of “−0.5 degrees” detected by the inclination detecting portion 63, thereby correcting the inclination of the image Im1. Accordingly, the image reading apparatus 2 corrects the inclination of the image Im1 without using the mechanical resist mechanism and solves the problems of the mechanical resist mechanism (the time to read takes time and a collision generates sound).

In this embodiment, the initial rotation angle is updated every time the inclination correcting portion 64 performs correction. That is, the inclination correcting portion 64 updates the initial rotation angle stored in the storage portion 25 every time the inclination correcting portion 64 corrects the inclination of the image Im1 of a sheet Sh1. For example, the inclination correcting portion 64 updates the initial rotation angle so that a rotation angle of the image Im1 rotated by correction becomes a new initial rotation angle. As an example, when correcting the inclination of the image Im1 of the sheet Sh1 by rotating “0.5 degrees” in a plus direction, the inclination correcting portion 64 sets a new initial rotation angle to “0.5 degrees”. Accordingly, after correction by the inclination correcting portion 64, the rotation processing portion 61 starts and performs rotation processing for the image Im1 of a new sheet Sh1 on the basis of the updated initial rotation angle. Thus, an initial rotation angle can be set for, for example, skew (inclination) caused by aged deterioration, thereby leading to reduction of load on the rotation processing, improvement in the processing speed and reduction of memory resources, which are required for the rotation processing.

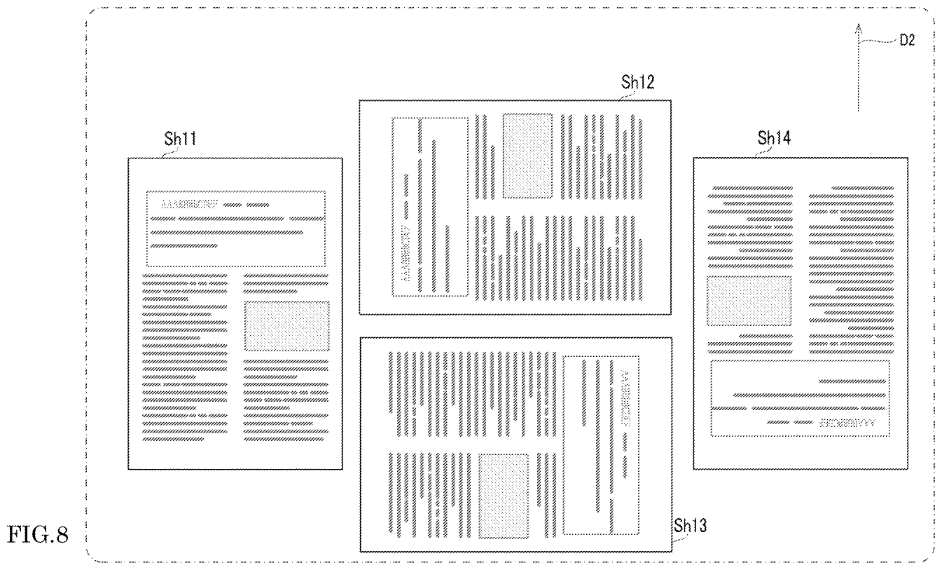

The designating portion 65 designates the direction of a symbol when a sheet Sh1 is set. The direction of the symbol with respect to the conveyance direction of the sheet Sh1 changes depending on the direction of the sheet Sh1 to be set. That is, the sheet Sh1 to be read in the second reading method (sheet-through reading method) is set on the document set portion 71 of the document cover 5, so that the direction of the symbol with respect to the conveyance direction changes depending on the direction of the sheet to be set. Specifically, as illustrated in FIG. 8, the directions of the symbol with respect to the conveyance direction of the sheet Sh1 (i.e., the direction that the sheet Sh1 is set) includes four ways with respect to the conveyance direction (sub-scanning direction D2). In other words, the directions of the sheet Sh1 to be conveyed in its longitudinal direction include two ways of sheets Sh11, Sh14 and to be conveyed in its lateral direction include two ways of sheets Sh12, Sh13 both in FIG. 8. If the recognition processing portion 62 is burdened with the recognition processing of these four directions, the number of standard patterns for the recognition processing will increase, the resources of the storage portion 25 will be constrained, the processing speed of the recognition processing will be delayed, and the recognition precision will decrease.

For that reason, the designating portion 65 in this embodiment designates the direction of a symbol to select one of the four directions for execution of the recognition processing when the sheet Sh1 is set. That is, the designating portion 65 designates the direction of the symbol for conveyance (letter and number) of the target of recognition to align with any of those shown in FIG. 8 when the sheet Sh1 is set. For example, when the sheet Sh11 in FIG. 8 is to be designated, the designating portion 65 displays the text “please set the document so that the upper part of the letters direct leftward” on the operation display portion 11. In addition, the designating portion 65 may designate the direction of the symbol using notation of a seal or output of voice, for example, instead of the display of the operation display portion 11. This configuration allows reduction of resources of the storage portion 25 for recognition processing, increase of processing speed for the recognition processing and improvement of recognition precision.

[3] Image Processing Method

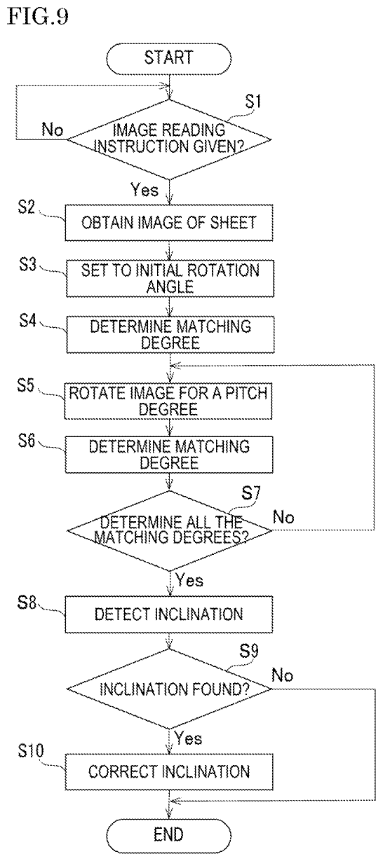

Next, an image processing method according to the present embodiment, which is an operation of the image reading apparatus 1, will be described with reference to FIG. 9. The reference numerals S1 to S10 in the steps in FIG. 9 indicate the order of the processing (stages) performed by the processing portion 6. The processing portion 6 is mainly composed of a computer system having one or more processors and one or more memories, so that execution of program by one or more processors achieves the processing below.

[Step S1]

In Step 1, the processing portion 6 determines whether an image reading instruction is inputted through a user operation. Here, the processing portion 6 determines that the image reading instruction is inputted (S1: Yes) in response to an operation to start image reading in the second reading method (sheet-through reading method) and moves the process to Step S2. On the other hand, the processing portion 6 repeats Step 1 if it determines that the operation to start the image reading in the second reading method is not completed and the image reading instruction is not inputted (S1: No).

[Step S2]

In Step S2, the processing portion 6 obtains the image of the sheet Sh1 conveyed by the ADF 7. Specifically, the processing portion 6 instructs the image reading portion 2 to perform a reading operation at the timing that the sheet Sh1 conveyed on the conveyance path L1 passes the reading position P1. Thus, the image reading portion 2 reads the image of the sheet Sh1 through the second contact glass 42. Then, the processing portion 6 obtains the image Im1 of the sheet Sh1 read by the reading operation above.

[Step S3]

In Step S3, the rotation processing portion 61 of the processing portion 6 sets the image Im1 of the sheet Sh1 to the initial rotation angle. Here, the rotation processing process 61 reads out the initial rotation angle from the storage portion 25 and rotates the image Im1 of the sheet Sh1 obtained in Step S2 for the initial rotation angle. With this, the comparative image with the rotation angle θ1 of “0 degree” is generated.

[Step S4]

In Step S4, the recognition processing portion 62 of the processing portion 6 determines the matching degree of the (first) comparative image generated in Step S3 through recognition processing of a symbol. In other words, the recognition processing portion 62 performs recognition processing for the image Im1 of before rotation processing, which is the first comparative image, to determine the matching degree. The recognition processing portion 62 associates the determined matching degree with the rotation angle θ1 of the comparative image and stores it in the table (see FIG. 7) of the storage portion 25.

[Step S5]

In Step S5, the rotation processing portion 61 of the processing portion 6 rotates the image Im1 of the sheet Sh1 for a pitch angle. Here, for the first rotation processing, the rotation processing portion 61 rotates the image Im1 for a pitch angle in the plus direction on the basis of the initial rotation angle. This generates a comparative image with the rotation angle θ1 of “0.5 degrees”.

[Step S6]

In Step S6, the recognition processing portion 62 determines the matching degrees for the (second and subsequent) comparative images generated in Step S5 through recognition processing of the symbols. In other words, the recognition processing portion 62 determines the matching degrees for the images Im1 of after rotation processing, which are the second and subsequent comparative images. The recognition processing portion 62 associates the determined matching degrees with the rotation angles 81 of the comparative images and stores them in the table (see FIG. 7) of the storage portion 25.

[Step S7]

In Step S7, the recognition processing portion 62 of the processing portion 6 determines whether all of the multiple comparative images have been determined the matching degrees. As an example, in the present embodiment, the rotation processing portion 61 generates a total of 11 comparative images in the range of 5.0 degrees in total including the plus direction of 2.5 degrees, with a pitch angle of 0.5 degrees, and in the minus direction of 2.5 degrees, with a pitch angle of 0.5 degrees, both on the basis of the initial rotation angle. If the recognition processing portion 62 determines that all of the 11 comparative images have been completed in determination of the matching degrees (S7: Yes), it moves the processing to Step 8. On the other hand, if the recognition processing portion 62 determines that even one of the 11 comparative images has not been completed in determination of the matching degree (S7: No), it moves the processing to Step 5.

Accordingly, the processing portion 6 repeats the rotation processing (Step 5) and the recognition processing (Step 6) until the matching degrees of all the multiple comparative images are determined. After determination of the matching degrees for the multiple comparative images (S7: Yes), the processing portion 6 moves the processing to Step 8.

[Step S8]

In Step S8, the inclination portion 63 of the processing portion 6 detects the inclinations of the images Im1 of the sheet Sh1 based on the matching degrees. In this embodiment, the inclination detecting portion 63 detects the inclination angle of the image Im1 of the original sheet Sh1 from the rotation angle 81 of the comparative image having the highest matching degree among the matching degrees determined in Step 4 and Step 6. Specifically, the inclination detecting portion 63 detects the positive-negative reversed angle of the rotation angle θ1 of the comparative image having the highest matching degree among the multiple comparative images, each having a different rotation angle θ1, as the inclination angle of the image Im1 of the original sheet Sh1.

[Step S9]

In Step 9, the inclination correction portion 64 of the processing portion 6 determines whether the image Im1 of the sheet Sh1 has an inclination. Here, the inclination correction portion 64 determines that the image has an inclination if the inclination angle detected in Step S8 is greater than a predetermined angle (S9: Yes) and moves the processing to Step S10. In contrast, if the inclination angle is less than the predetermined angle (S9: No), the inclination correction portion 64 determines that the image does not have an inclination and ends the series of processing, skipping Step S10.

[Step S10]

In Step S10, the inclination correction portion 64 of the processing portion 6 corrects the inclination of the image Im1 of the sheet Sh1 obtained in Step S2. Here, the inclination correction portion 64 rotates the image Im1 in a direction opposite the inclined direction of the image Im1 for the inclination angle detected by Step S8 to correct the inclination of the image Im1 of the sheet Sh1 so that the sheet Sh1 comes to an upright direction where the sheet Sh1 does not have an inclination. With this, the processing portion ends the series of processing.

The processing of the image processing method described above is merely an example and thus the order of the processing illustrated in the flowchart of FIG. 9 may be changed as appropriate or additional processing may be included therein.

[4] Modified Example

The plurality of components included in the image reading device 1 may be divided and provided in a plurality of housings. For example, at least one of the rotation processing portion 61, the recognition processing portion 62, the inclination detecting portion 63, the inclination correction portion 64 and the designation portion 65 may be configured not to work as one of the functions of the processing portion 6 and may be provided in a housing separate from the processing portion 6.

In addition, the image reading apparatus 1 may at least have an image (image data) reading function and may not necessarily have the image forming portion 3. The image reading apparatus 1 may not have a function (image forming portion 3) to form an image, and it may be a scanner or facsimile device, etc., that outputs a read image outside.

In addition, the image reading apparatus 1 does not necessarily have two types of image reading methods which are the first reading method (document fixed reading method) and the second reading method (sheet-through reading method). That is, the image reading apparatus may not have an image reading function of the document fixed reading method as long as it has an image reading function of the sheet-through reading method.

The recognition processing by the recognition processing portion 62 is not limited to the Optical Character Recognition using the feature amount described in the first embodiment. For example, the recognition processing portion 62 may perform recognition processing of the symbol using a simple pattern matching wherein a pattern of normalized letter (or number) is compared with a pre-recorded template of the same form. Furthermore, the target to be recognized by the recognition processing portion 62 is not limited to the letter and number and may be, for example, a mark (symbol in a narrow sense), letter, number, figure and picture or a combination thereof.

Provision of the inclination correction portion 64, which corrects inclination of the image Im1 in response to the inclination detected by the inclination detecting portion 63, is not an essential structure for the image reading apparatus 1. In other words, the inclination to be detected by the inclination detecting portion 63 may be used for correction of inclination. In this case, the processing portion 6 may display the inclination (inclination angle) detected by the inclination detecting portion 63 on the operation display portion 11 and may stop the conveyance of the sheet Sh1 when the inclination detected by the inclination detecting portion 63 exceeds the allowance, for example.

The recognition processing portion 62 does not necessarily apply recognition processing to only one of the divided multiple zones R1 to R5 of the image Im1 of the sheet Sh1 and it may apply the recognition processing to the entire image Im1. In addition, the inclination detecting portion 63 does not necessarily detect the inclination of each of the multiple zones R1 to R5 and may detect the inclination from the entire image Im1. Updating the initial rotation angle each time of correction by the correction portion 64 is not essential, that is the initial rotation angle may be a fixed value, for example. Providing the designating portion 65, which designates the direction of the symbol of the sheet Sh1 when it is set, is not an essential structure for the image reading apparatus 1.

In the first embodiment, the relation between the density and the density value is defined so that the lower density has a larger density value; however, the relation between them may be defined so that the higher density has a larger density value, for example.

(Second Embodiment)

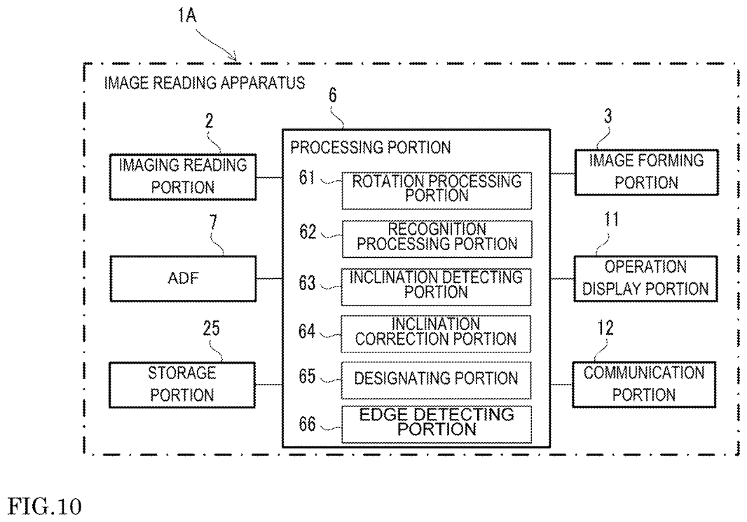

The image reading apparatus 1A according to the second embodiment differs from the image reading apparatus 1 according to the first embodiment in that the former includes an edge detecting portion 66 as illustrated in FIG. 10. The components similar to those in the first embodiment are provided with the same reference numerals and the description thereof will be omitted.

The edge detecting portion 66 detects an edge of the sheet Sh1 based on the comparison between the density value of the image Im1 read by the image reading portion 2 and a threshold. Specifically, the edge detecting portion 66 detects an edge using a shade developed by the edge of the sheet Sh1. That is, in the second reading method (sheet-through reading method), the light emitted from the light source 201 to the edge of the sheet Sh1 develops a shade around the edge when the edge of the sheet Sh1 conveyed by the ADF 7 passes near the reading position P1. The edge detecting portion 66 detects the edge of the sheet Sh1 by extracting the shade from an image read by the image reading portion 2. Specifically, the edge detecting portion 66 compares the density value of the image read by the image reading portion 2 with the threshold and determines the pixel of the density value at a higher density side than the threshold as the “shade”. With this, the edge detecting portion 66 detects the shade around the edge, identifying the edge of the sheet Sh1. In this embodiment, the lower density has a higher density value, so that the edge detecting portion 66 determines the pixel of the density value lower than the threshold as the “shadow”.

The inclination detecting portion 63 in this embodiment detects the inclination (of the image Im1) based on the inclination of the edge when the edge is detected, and detects the inclination (of the image Im1) based on the matching degree when the edge is not detected. Specifically, the inclination detecting portion 63 is able to use two information as the information to detect the inclination of the image Im1 of the sheet Sh1; one is the edge of the sheet to be detected by the edge detecting portion 66 and the other is the matching degree of each of the multiple comparative images determined by the recognition processing portion 62. In this embodiment, when the edge is detected, the inclination detecting portion 63 detects the inclination of the image Im1 based on the inclination of the edge and not based on the matching degree in order to prioritize the edge information. This allows the image reading apparatus 1A to perform a precise detection of the skew (inclination), which is the inclination of the sheet Sh1 itself, based on the inclination of the edge, when the edge detecting portion 66 is able to detect the edge.

Furthermore, in the image reading apparatus 1A of the present embodiment, the initial rotation angle may be updated only when the inclination correction portion 64 performs correction based on the edge of the sheet Sh1 detected by the edge detecting portion 66. That is, when the inclination of the image Im1 is corrected based on the matching degree because no edge is detected, the initial rotation angle is not updated even if the inclination correction portion 64 performs correction. When the inclination of the image Im1 is corrected based on the edge, the inclination correction portion 64 updates the initial rotation angle each time the correction is performed.

As a modified example of the second embodiment, the inclination detecting portion 63 may detect the inclination of the image Im1 of the sheet Sh1 based on both the edge of the sheet Sh1 detected by the edge detecting portion 66 and the matching degree of each of the multiple comparative images determined by the recognition processing portion 62. As an example, the inclination detecting portion 63 detects an average value between the inclination angle detected based on the edge of the sheet Sh1 and the inclination angle detected based on the matching degree, as the inclination of the image Im1. The structure (including the modified example) of the second embodiment may be applied in combination with any component (including the modified example) described in the first embodiment.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image reading apparatus comprising:
an image reading portion reading an image of a sheet conveyed through a conveyance path;
a rotation processing portion applying rotation processing to the image of the sheet read by the image reading portion to generate a plurality of comparative images each having a different angle with respect to the conveyance direction of the sheet;
a recognition processing portion applying recognition processing to a symbol of each of the plurality of comparative images to determine a corresponding matching degree; and
an inclination detecting portion detecting an inclination of the image of the sheet based on the matching degrees.

2. The image reading apparatus of claim 1 further comprising an inclination correction portion correcting the inclination of the image read by the image reading portion in response to the inclination detected by the inclination detecting portion.

3. The image reading apparatus of claim 2, wherein
the rotation processing portion performs the rotation processing on the basis of an initial rotation angle; and
the initial rotation angle is updated each time the inclination correction portion performs correction.

4. The image reading apparatus of claim 1, wherein
the recognition processing portion applies recognition processing to at least one of a plurality of divided zones of the image of the sheet.

5. The image reading apparatus of claim 4, wherein the recognition processing portion applies recognition processing to each of the plurality of zones, and
the inclination detecting portion detects the inclination of each of the plurality of zones.

6. The image reading apparatus of claim 1 further comprising a designating portion designating the direction of the symbol at the time the sheet is set.

7. The image reading apparatus of claim 1 further comprising an edge detecting portion detecting an edge of the sheet based on the comparison between a density value of the image read by the image reading portion and a threshold, wherein
the inclination detecting portion detects the inclination based on the inclination of the edge when the edge is detected and based on the matching degree when the edge is not detected.

8. An image processing method comprising:
reading an image of a sheet conveyed through a conveyance path;
applying rotation processing to the image of the sheet read by the image reading portion to generate a plurality of comparative images each having a different angle with respect to the conveyance direction of the sheet;
applying recognition processing to a symbol of each of the plurality of comparative images to determine a corresponding matching degree; and
detecting an inclination of the image of the sheet based on the matching degrees.
